(19) United States
(12) Patent Application Publication
(10) Pub. No.: US 2010/0259533 A1
(43) Pub. Date: Oct. 14, 2010

(54) DISPLAY AND A METHOD OF DRIVING THE SAME

(75) Inventors: Junichi Yamashita, Tokyo (JP); Masakazu Kato, Kanagawa (JP); Katsuhide Uchino, Kanagawa (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, Tokyo (JP)

(21) Appl. No.: 12/731,750

(22) Filed: Mar. 25, 2010

(30) Foreign Application Priority Data
Apr. 9, 2009 (JP) 2009-094740

(51) Int. Cl. G06F 3/038

(52) U.S. Cl. 345/213

(57) ABSTRACT

A display includes: a pixel circuit array section including a plurality of light-emitting elements and a plurality of pixel circuits; a scanning line drive circuit sequentially selecting the plurality of light-emitting elements and the plurality of the pixel circuits; a signal line drive circuit writing a light emission potential corresponding to a signal potential to a selected pixel circuit; and a control circuit, in which in each frame period, the control circuit outputs a light-off control signal at a lapse of a first period after writing the light emission potential to the selected pixel circuit by the signal line drive circuit, and then the control circuit outputs a light-on control signal at a lapse of a second period, and after that, the control circuit outputs a light-off control signal at a lapse of a third period which is longer than the first period.

### BACKGROUND OF THE INVENTION

1. Field of the Invention

The present invention relates to a display including a light-emitting element and a method of driving the display.

2. Description of the Related Art

In recent years, in the field of displays displaying an image, displays using current drive type optical elements of which light emission luminance changes depending on the value of a current flowing therethrough, for example, organic EL (Electro Luminescence) elements as light-emitting elements of pixels have been developed for commercialization. Unlike liquid crystal elements or the like, the organic EL elements are self-luminous elements. Therefore, in a display (an organic EL display) using the organic EL elements, a light source (a backlight) is not necessary, so compared to a liquid crystal display needing a light source, a reduction in the profile of the display and an increase in the luminance of the display are allowed. In particular, in the case where the display uses an active matrix system as a drive system, each pixel is allowed to continuously emit light, and a reduction in power consumption is allowed. Therefore, the organic EL display is expected to become a mainstream of next-generation flat panel display.

Typically, Current-voltage (I-V) characteristics of the organic EL element deteriorate over time (temporally deteriorate). In a pixel circuit driving the organic EL element by a current, when the I-V characteristics of the organic EL element temporally changes, a voltage division ratio between the organic EL element and a driving transistor connected to the organic EL element in series is changed, thereby to also change a gate-to-source voltage V_{gs}. As a result, the value of a current flowing through the driving transistor changes, so the value of a current flowing through the organic EL element changes, thereby to change light emission luminance according to the value of the current flowing through the organic EL element.

Moreover, in some cases, a threshold voltage Vₜₕ or mobility μ of the driving transistor temporally changes, or the threshold voltage Vₜₕ or mobility μ varies among pixel circuits due to variations in a manufacturing process. In the case where the threshold voltage Vₜₕ or mobility μ of the driving transistor varies among pixel circuits, the value of a current flowing through the driving transistor varies among the pixel circuits, so even if the same voltage is applied to gates of the driving transistors in the pixel circuits, light emission luminance varies among organic EL elements, thereby to impair uniformity of a screen.

In order to, even in the case where the I-V characteristics of the organic EL elements temporally change or the threshold voltage Vₜₕ or mobility μ of the driving transistors temporally changes, keep light emission luminance of the organic EL elements uniform without influence of such a change, for example, as described in Japanese Unexamined Patent Application Publication No. 2008-083272, a display having a function of compensating for a change in I-V characteristics of the organic EL element and a function of correcting a change in the threshold voltage Vₜₕ or mobility μ of the driving transistor has been developed.

### SUMMARY OF THE INVENTION

In the above-described correction of the threshold voltage Vₜₕ, source voltages of the driving transistors are set to a negative potential, thereby the organic EL elements are reverse-biased. At this time, a leakage current slightly flows through the organic EL elements, but in the case where the magnitude of the leakage current varies among pixels, the anode voltages of the organic EL elements vary according to the magnitude of the leakage current. For example, in the case where a predetermined pattern including white and black is displayed for a long time, the magnitude of a leakage current in a pixel corresponding to white display is largely different from the magnitude of a leakage current in a pixel corresponding to black display. As a result, a change in luminance according to the pattern remains, thereby to cause burn-in.

Therefore, for example, to reduce a period where a reverse bias is applied to the organic EL element, a system in which the organic EL element emits light immediately before starting the correction of the threshold voltage Vₜₕ is considered. However, in this system, it is necessary to fix a light-on period, so the light-on period is unchangeable. As a result, there is an issue that it is difficult to control luminance by the light-on period.

It is desirable to provide a display allowed to prevent burn-in on a panel while having flexibility in a light-on period, and a method of driving the display.

According to an embodiment of the invention, there is provided a display including a pixel circuit array section including a plurality of scanning lines and a plurality of light-on/off control lines which are arranged in a row direction, a plurality of signal lines which are arranged in a column direction, and a plurality of light-emitting elements and a plurality of pixel circuits which are arranged in a matrix form corresponding to intersections between the scanning lines and the signal lines, respectively. The display further includes a scanning line drive circuit sequentially applying a selection pulse to the plurality of scanning lines so as to sequentially select the plurality of light-emitting elements and the plurality of the pixel circuits, and a signal line drive circuit applying a signal potential corresponding to a picture signal to each of the signal lines so as to write a light emission potential corresponding to the signal potential to a selected pixel circuit. The display further includes a control circuit sequentially applying a light-on control signal to the plurality of light-on/off control lines so as to allow a steady current corresponding to the light emission potential to flow into a selected light-emitting element, and sequentially applying a light-off control signal to the plurality of light-on/off control lines so as to stop the steady current flowing through the selected light-emitting element. In this case, in each frame period, the control circuit outputs the light-off control signal (a first light-off control signal) at a lapse of a first period after writing the light emission potential to the selected pixel circuit by the signal line drive circuit. Then, the control circuit outputs the light-on control signal at a lapse of a second period, and after that, the control circuit outputs the light-off control signal (a second light-off control signal) at a lapse of a third period which is longer than the first period.

According to an embodiment of the invention, there is provided a method of driving a display executing the following three steps in each frame period in the following display:

(1) outputting a light-off control signal (a first light-off control signal) at a lapse of a first period after writing a light emission potential to a selected pixel circuit by a signal line drive circuit;

(2) after that, outputting a light-on control signal at a lapse of a second period; and

(3) after that, outputting a light-off control signal (a second light-off control signal) at a lapse of a third period which is longer than the first period.

In this case, the display used for executing the above-described steps includes a pixel circuit array section including a plurality of scanning lines and a plurality of light-on/off control lines which are arranged in a row direction, a plurality of signal lines which are arranged in a column direction, and a plurality of light-emitting elements and a plurality of pixel circuits which are arranged in a matrix form corresponding to intersections between the scanning lines and the signal lines, respectively. The display further includes a scanning line drive circuit sequentially applying a selection pulse to the plurality of scanning lines so as to sequentially select the plurality of light-emitting elements and the plurality of the pixel circuits; and a signal line drive circuit applying a signal potential corresponding to a picture signal to each of the signal lines so as to write a light emission potential corresponding to the signal potential to a selected pixel circuit. The display further includes a control circuit sequentially applying a light-on control signal to the plurality of light-on/off control lines so as to allow a steady current corresponding to the light emission potential to flow into a selected light-emitting element, and sequentially applying a light-off control signal to the plurality of light-on/off control lines so as to stop the steady current flowing through the selected light-emitting element.

In the display and the method of driving a display according to the embodiment of the invention, the light-off control signal is outputted at a lapse of the first period after writing the light emission potential to the selected pixel circuit by the signal line drive circuit. Then, the light-on control signal is outputted at a lapse of the second period, and after that, the light-off control signal is outputted at a lapse of the third period which is longer than the first period. Thereby, the duration of a light-off period corresponding to the second period is appropriately adjusted so as to change a light-on period corresponding to the third period.

In the display and the method of driving a display according to the embodiment of the invention, the duration of the light-off period is appropriately adjusted, thereby the light-on period is allowed to be changed, so while having flexibility in the light-on period, burn-in on a panel is preventable.

Other and further objects, features and advantages of the invention will appear more fully from the following description.

### BRIEF DESCRIPTION OF THE DRAWINGS

FIG. 1 is a schematic configuration diagram of a display according to an embodiment of the invention.

FIG. 2 is a configuration diagram of an example of a pixel circuit array section.

FIG. 3 is a waveform chart for describing an example of operation of the display in FIG. 1.

FIGS. 4A, 4B and 4C are schematic views of an example of a monochrome image displayed on a display panel in FIG. 1, and a characteristic chart illustrating luminance of the display panel after displaying the monochrome image.

FIGS. 5A and 5B are plots illustrating I-V characteristics of an organic EL element in FIG. 2.

FIG. 6 is a waveform chart for describing an example of operation of a display according to a comparative example.

FIG. 7 is a waveform chart for describing an example of operation of a display according to another comparative example.

FIG. 8 is a waveform chart for describing another example of operation of the display in FIG. 1.

FIG. 9 is a waveform chart for describing still another example of operation of the display in FIG. 1.

FIG. 10 is a configuration diagram of another example of the pixel circuit array section in FIG. 1.

FIG. 11 is a configuration diagram of still another example of the pixel circuit array section in FIG. 1.

FIG. 12 is a schematic plan view of a module including the display according to the above-described embodiment.

FIG. 13 is an external perspective view of Application Example 1 of the display according to the above-described embodiment.

FIGS. 14A and 14B are an external perspective view from the front side of Application Example 2 and an external perspective view from the back side of Application Example 2, respectively.

FIG. 15 is an external perspective view of Application Example 3.

FIG. 16 is an external perspective view of Application Example 4.

FIGS. 17A to 17G illustrate Application Example 5, FIGS. 17A and 17B are a front view and a side view in a state in which Application Example 5 is opened, respectively, and FIGS. 17C, 17D, 17E, 17F and 17G are a front view, a left side view, a right side view, a top view and a bottom view in a state in which Application Example 5 is closed, respectively.

### DETAILED DESCRIPTION OF THE PREFERRED EMBODIMENTS

A preferred embodiment will be described in detail below referring to the accompanying drawings. In addition, descriptions will be given in the following order.

### 1. Embodiment

1.1 Schematic configuration of display
1.2 Operation of display
1.3 Functions and effects

### 2. Modifications

### 3. Module and Application Examples

### 1. Embodiment

### 1.1 Schematic Configuration of Display

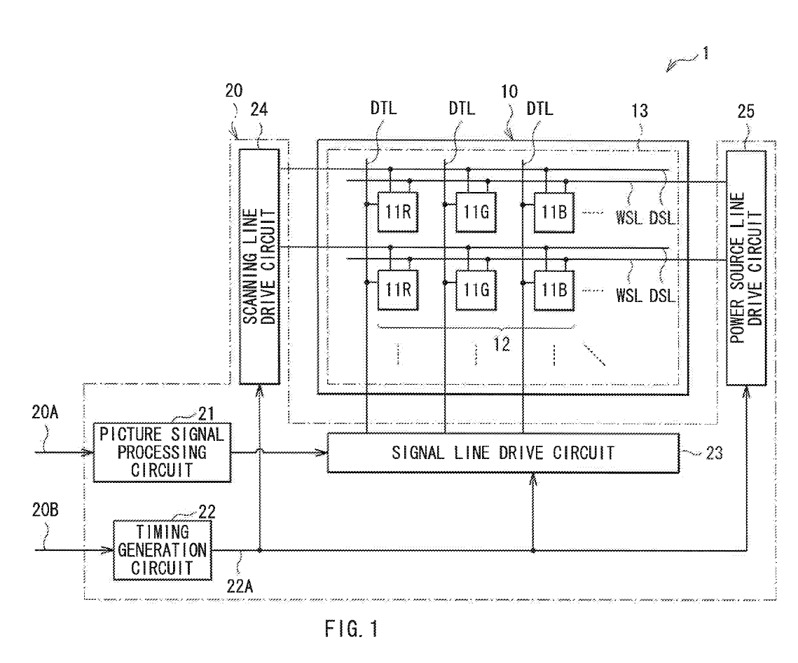

FIG. 1 illustrates a schematic configuration of a display according to an embodiment of the invention. The display 1 includes a display panel 10 and a drive circuit 20 driving the display panel 10. The display panel 10 includes, for example, a pixel circuit array section 13 including a plurality of organic EL elements 11R, 11G and 11B (light-emitting elements) which are arranged in a matrix form. In the embodiment, for example, three adjacent organic EL elements 11R, 11G and 11B form one pixel 12. In addition, the organic EL elements 11R, 11G and 11B are collectively called organic EL elements 11 as necessary. The drive circuit 20 includes, for example, a picture signal processing circuit 21, a timing generation circuit 22, a signal line drive circuit 23, a scanning line drive circuit 24 and a power source line drive circuit 25 (a control circuit).

Pixel Circuit Array Section

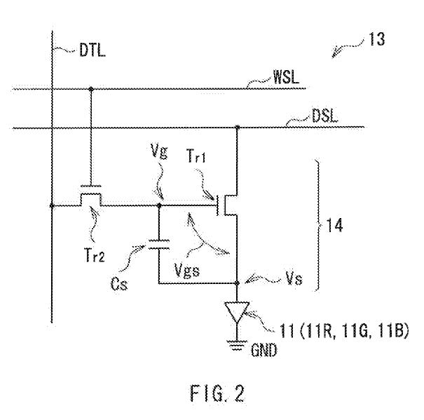

FIG. 2 illustrates an example of a circuit configuration of the pixel circuit array section 13. The pixel circuit array section 13 is formed in a display region of the display panel 10. As illustrated in FIGS. 1 and 2, the pixel circuit array section 13 includes, for example, a plurality of scanning lines WSL arranged in a row direction, a plurality of signal lines DTL arranged in a column direction, and power source lines DSL (light-on/off control lines) arranged in the row direction along the scanning lines WSL. A plurality of organic EL elements 11 and pixel circuits 14 are arranged in a matrix form (two-dimensionally arranged) corresponding to intersections of the scanning lines WSL and the signal lines DTL, respectively. Each pixel circuit 14 includes, for example, a driving transistor Tr₁, a writing transistor Tr₂ and a retention capacitor Cₛ, that is, the pixel circuit 14 has a 2Tr1C circuit configuration. The driving transistor Tr₁ and the writing transistor Tr₂ each are configured of, for example, an n-channel MOS type thin film transistor (TFT). In addition, the kind of the TFT is not specifically limited, and may be, for example, an inverted stagger configuration (a so-called bottom gate type) or a stagger configuration (a top gate type). Moreover, the driving transistor Tr₁ and the writing transistor Tr₂ each may be a p-channel MOS type TFT.

In the pixel circuit array section 13, each of the signal lines DTL is connected to an output end (not illustrated) of the signal line drive circuit 23 and a drain electrode (not illustrated) of the writing transistor Tr₂. Each of the scanning lines WSL is connected to an output end (not illustrated) of the scanning line drive circuit 24 and a gate electrode (not illustrated) of the writing transistor Tr₂. Each of the power source lines DSL is connected to an output end (not illustrated) of the power source line drive circuit 25 and a drain electrode (not illustrated) of the driving transistor Tr₁. A source electrode (not illustrated) of the writing transistor Tr₂ is connected to a gate electrode (not illustrated) of the driving transistor Tr₁ and an end of the retention capacitor Cₛ. A source electrode (not illustrated) of the driving transistor Tr₁ and the other end of the retention capacitor Cₛ are connected to an anode electrode (not illustrated) of the organic EL element 11. A cathode electrode (not illustrated) of the organic EL element 11 is connected to, for example, a ground line GND. In addition, the cathode electrode is used as a common electrode for all of the organic EL elements 11, and is continuously formed, for example, over the whole display region of the display panel 10, and has a flat plate shape.

Drive Circuit

Next, each circuit in the drive circuit 20 arranged around the pixel circuit array section 13 will be described below referring to FIG. 1. The picture signal processing circuit 21 performs predetermined correction on a digital picture signal 20A inputted from outside, and converts the corrected picture signal into an analog signal to output the analog signal to the signal line drive circuit 23. Examples of the predetermined correction include gamma correction, overdrive correction and the like. The timing generation circuit 22 controls the signal line drive circuit 23, the scanning line drive circuit 24 and the power source line drive circuit 25 to operate in synchronization with one another. The timing generation circuit 22 outputs a control signal 22A to these circuits in response to (in synchronization with) a synchronization signal 20B inputted from outside.

The signal line drive circuit 23 applies an analog picture signal (a signal voltage corresponding to the picture signal 20A) inputted from the picture signal processing circuit 21 to each signal line DTL so as to write a light emission potential corresponding to the signal voltage to a selected pixel 14. More specifically, the light emission potential is a voltage applied between a gate and a source of the driving transistor Tr₁. The signal line drive circuit 23 is allowed to output, for example, a signal voltage S_{sig} corresponding to the picture signal 20A and a voltage V_{ofs} which is applied to the gate of the driving transistor Tr₁ during turning the organic EL element 11 off. In this case, the voltage V_{ofs} has a voltage value (a fixed value) which is lower than a threshold voltage Vₑ₁ of the organic EL element 11, and is higher than the minimum voltage of the signal voltage V_{sig}.

The scanning line drive circuit 24 sequentially applies a selection pulse to a plurality of scanning lines WSL in response to (in synchronization with) input of the control signal 22A to sequentially select a plurality of the organic EL elements 11 and a plurality of the pixel circuits 14. The scanning line drive circuit 24 is allowed to output, for example, a voltage Vₒₙ applied when turning the writing transistor Tr₂ on and a voltage V_{off} applied when turning the writing transistor Tr₂ off In this case, the voltage Vₒₙ has a value (a fixed value) equal to or higher than an ON voltage of the writing transistor Tr₂. The voltage V_{off} has a value (a fixed value) lower than the ON voltage of the writing transistor Tr₂.

The power source line drive circuit 25 controls the organic EL element 11 to be turned on/off in response to (in synchronization with) input of the control signal 22A. More specifically, the power source line drive circuit 25 sequentially applies a light-on control signal to a plurality of power source line DSL so as to allow a steady current corresponding to a light emission potential to flow through a selected organic EL element 11. Moreover, the power source line drive circuit 25 sequentially applies a light-off control signal to a plurality of power source lines DSL to stop the steady current flowing through the selected organic EL element 11.

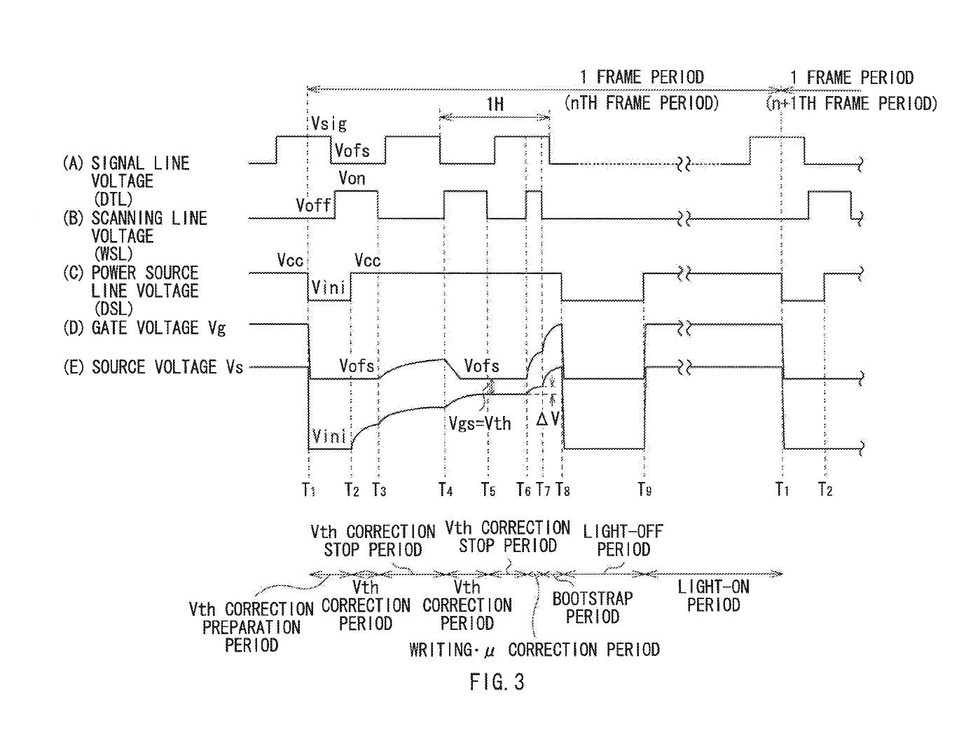

In this case, the light-off control signal is a signal for stopping a current I_{d} flowing between the drain and the source of the driving transistor Tr₁. The light-off control signal is, for example, a falling signal 25A (refer to FIG. 3) for changing the potential of the power source line DSL from a voltage V_{cc} which will be described later to a voltage Vᵢₙᵢ when the gate of the driving transistor Tr₁ is floating. As will be described later, the light-off control signal is applied to the power source line DSL after a lapse of a writing period in one frame period. The light-on control signal is a signal for flowing the current I_{d} between the drain and the source of the driving transistor Tr₁. The light-on control signal is, for example, a rising signal 25B (refer to FIG. 3) for changing the potential of the power source line DSL from the voltage Vᵢₙᵢ which will be described later to the voltage V_{cc} when the gate of the driving transistor Tr₁ is floating. As will be described later, the light-on control signal is applied to the power source line DSL after a lapse of the wiring period in the one frame period as well as after applying the light-off control signal to the power source line DSL.

For example, the power source line drive circuit 25 is allowed to output the voltage V_{cc} which is applied when a steady current is allowed to flow through the driving transistor Tr₁ and the voltage Vᵢₙᵢ which is applied when the steady current is not allowed to flow through the driving transistor Tr₁. In this case, the voltage Vᵢₙᵢ has a voltage value (a fixed value) lower than a voltage (Vₑ₁+V_{ca}) obtained by combining the threshold voltage Vₑ₁ of the organic EL element 11 and a voltage V_{ca} of a cathode of the organic EL element 11. The voltage V_{cc} has a voltage value (a fixed value) equal to or higher than the voltage (Vₑ₁+Vₑₐ).

### 1.2 Operation of Display

FIG. 3 illustrates an example of various waveforms when the display 1 is driven. FIGS. 3(A) to (C) illustrate a state in which the voltages V_{sig} and V_{ofs} are alternately applied to the signal line DTL, and a state in which the voltages Vₒₙ and V_{off} are applied to the scanning line WSL at predetermined timings, and a state in which the voltages V_{cc} and Vᵢₙᵢ are applied to the power source line DSL at predetermined timings, respectively. FIGS. 3(D) and (E) illustrate states in which a gate voltage V_{g} and a source voltage Vₛ of the driving transistor Tr₁ are momentarily changed with the application of voltages to the signal line DTL, the scanning line WSL and the power source line DSL.

Vₜₕ Correction Preparation Period

First, preparation for Vₜₕ correction is made. More specifically, the power source line drive circuit 25 drops the voltage of the power source line DSL from the voltage V_{cc} to the voltage Vᵢₙᵢ (T₁). Thereby, the source voltage Vₛ is changed to the voltage Vᵢₙᵢ to turn the organic EL element 11 off, and the gate voltage V_{g} is decreased to the voltage V_{ofs}. Next, after the signal line drive circuit 23 switches the voltage of the signal line DTL from the voltage V_{sig} to the voltage V_{ofs}, and while the voltage of the power source line DSL is at the voltage Vᵢₙᵢ, the scanning line drive circuit 24 raises the voltage of the scanning line WSL from the voltage V_{off} to the voltage Vₒₙ. In addition, a Vₜₕ correction preparation period corresponds to a specific example of “a fourth period” in the invention.

In this case, the Vₜₕ correction preparation period, more specifically a period (from T₁ to T₃) from when turning the organic EL element 11 off to when raising the voltage of the power source line DSL from the voltage Vᵢₙᵢ to the voltage V_{cc} by the power source line drive circuit 25 is approximately 1 ms (millisecond) or less, and preferably approximately 0.5 ms (milliseconds) or less. In addition, a preferable duration of the Vₜₕ correction preparation period will be described in detail later.

First Vₜₕ Correction Period

Next, Correction on the voltage Vₜₕ is performed. More specifically, while the voltage of the signal line DTL is at the voltage V_{ofs}, the power source line drive circuit 25 raises the voltage of the power source line DSL from the voltage Vᵢₙᵢ to the voltage V_{cc} (T₂). Then, the current I_{d} flows between the drain and the source of the driving transistor Tr₁, and the source voltage Vₛ is increased. After that, before the signal line drive circuit 23 switches the voltage of the signal line DTL from the voltage V_{ofs} to the voltage V_{sig}, the scanning line drive circuit 24 drops the voltage of the scanning line WSL from the voltage Vₒₙ to the voltage V_{off} (T₃). As a result, the gate of the driving transistor Tr₁ is turned to a floating state, thereby the correction of the voltage Vₜₕ temporarily stops.

First Vₜₕ Correction Stop Period

During a period where the correction of the voltage Vₜₕ stops, sampling of the voltage of the signal line DTL is performed in a line (a pixel) different from a line (a pixel) on which the correction of the voltage Vₜₕ has already been performed. In addition, in the case where the correction of the voltage Vₜₕ is insufficient, that is, in the case where a potential difference V_{gs} between the gate and the source of the driving transistor Tr₁ is larger than the threshold voltage Vₜₕ of the driving transistor Tr₁, what happens is as follows. That is, even during a Vₜₕ correction stop period, the current I_{ds} flows between the drain and the source of the driving transistor Tr₁ in the line (pixel) on which the correction of the voltage Vₜₕ has already been performed, and the source voltage Vₛ is increased, and the gate voltage V_{g} is also increased by coupling through the retention capacitor Cₛ.

Second Vₜₕ Correction Period

After the Vₜₕ correction stop period is completed, the correction of the voltage Vₜₕ is performed again. More specifically, when the voltage of the signal line DTL is at the voltage Vₐₛ, thereby to allow the correction of the voltage Vₜₕ, the scanning line drive circuit 24 raises the voltage of the scanning line WSL from the voltage V_{off} to the voltage Vₒₙ (Tₐ), and the gate of the driving transistor Tr₁ is connected to the signal line DTL. At this time, in the case where the source voltage Vₛ is lower than a value (V_{ofs}−Vₜₕ) (in the case where the correction of the voltage Vₜₕ is not yet completed), the current I_{d} flows between the drain and the source of the driving transistor Tr₁ until cutting the driving transistor Tr₁ off (until the potential difference reaches the voltage Vₜₕ). As a result, the retention capacitor Cₛ is charged to the voltage Vₜₕ, and the potential difference V_{gs} reaches the voltage Vₜₕ. After that, before the signal line drive circuit 23 switches the voltage of the signal line DTL from the voltage Vₐₛ to the voltage V_{sig}, the scanning line drive circuit 24 drops the voltage of the scanning line WSL from the voltage Vₒₙ to the voltage V_{off} (T₅). Thereby, the gate of the driving transistor Tr₁ turns into a floating state, so the potential difference V_{gs} is allowed to be kept at the voltage Vₜₕ irrespective of the magnitude of the voltage of the signal line DTL. Thus, when the potential difference V_{gs} is set to the voltage Vₜₕ, even if the threshold voltage Vₜₕ of the driving transistor Tr₁ varies among the pixel circuits 14, variations in light emission luminance among the organic EL elements 11 are preventable.

Second Vₜₕ Correction Stop Period

After that, during the Vₜₕ correction stop period, the signal line drive circuit 23 switches the voltage of the signal line DTL from the voltage V_{ofs} to the voltage V_{sig}.

Writing·μ Correction Period

After the Vₜₕ correction stop period is completed, writing and μ correction are performed. More specifically, while the voltage of the signal line DTL is at the voltage V_{sig}, the scanning line drive circuit 24 raises the voltage of the scanning line WSL from the voltage V_{off} to the voltage Vₒₙ (T_{b}), and the gate of the driving transistor Tr₁ is connected to the signal line DTL. Thereby, the gate voltage of the driving transistor Tr₁ is changed to the voltage V_{sig}. At this time, an anode voltage of the organic EL element 11 at this stage is still smaller than a threshold voltage Vₑ₁ of the organic EL element 11, so the organic EL element 11 is cut off. Therefore, the current I_{ds} flows into an element capacitance (not illustrated) of the organic EL element 11, and the element capacitance is charged, so the source voltage Vₛ is increased only by a voltage ΔV, and then the potential difference V_{gs} reaches V_{sig}+Vₜₕ−ΔV. Thus, μ correction is performed concurrently with writing. In this case, the larger mobility μ of the driving transistor Tr₁ is, the more the voltage ΔV is increased, so when the potential difference V_{gs} is reduced only by the voltage ΔV before light emission, variations in mobility among the pixel circuits 14 are preventable.

Bootstrap Period (T_{b})

Next, the scanning line drive circuit 24 drops the voltage of the scanning line WSL from the voltage Vₒₙ to the voltage V_{off} (T₇). Thereby, the gate of the driving transistor Tr₁ is turned into a floating state, and the current I_{d} flows between the drain and the source of the driving transistor Tr₁ in a state in which the voltage V_{gs} between the gate and the source of the driving transistor Tr₁ is kept constant. As a result, the source voltage Vₛ is increased, and the gate voltage of the driving transistor Tr1 is also increased in conjunction with the source voltage Vs. In addition, a writing·μ correction period and a bootstrap period correspond to specific examples of “a first period” in the invention.

Light-Off Period

Next, immediately before, at the moment, or immediately after when the organic EL element 11 starts emitting light in the previous bootstrap period, the power source line drive circuit 25 drops the voltage of the power source line DSL from the voltage V_{cc} to the voltage Vᵢₙᵢ (T₉). Thereby, the source voltage Vₛ is decreased to the voltage Vᵢₙᵢ, and the organic EL element 11 stays off, or light emission from the organic EL element 11 stops instantly. In other words, the power source line drive circuit 25 applies the falling signal 25A (a first light-off control signal) to the power source line DSL to stop the steady current flowing through the selected organic EL element 11.

In this case, the bootstrap period (from T₇ to T₈) is too short to reach the time when the organic EL element 11 starts emitting light. Moreover, the bootstrap period (from T₇ to T₈) is too short for a viewer (not illustrated) to discriminate between light emission from the organic EL element 11 in the bootstrap period and light emission from the organic EL element 11 in a light-on period which will be described later. Moreover, a light-off period (from T₈ to T₉) is changed according to the light-on period which will be described later, and plays a role as an adjustment period when changing the light-on period. In addition, the light-off period correspond to a specific example of “a second period” in the invention.

Light-On Period (Tₑ)

Next, the power source line drive circuit 25 raises the voltage of the power source line DSL from the voltage Vᵢₙᵢ to the voltage V_{cc} (T₉). Thereby, the current I_{d} flows between the drain and the source of the driving transistor Tr1 in a state in which the voltage V_{gs} between the gate and the source of the driving transistor Tr₁ is kept constant. In other words, the power source line drive circuit 25 applies the rising signal 25B (a light-on control signal) to the power source line DSL, thereby a steady current is allowed to flow into the selected organic E1 element 11. As a result, the source voltage Vₛ is increased, and the gate voltage of the driving transistor Tr₁ is also increased in conjunction with the source voltage Vₛ. Thus, a bootstrap occurs again, and as a result, the organic EL element 11 emits light with desired luminance. In addition, the light-on period corresponds to a specific example of “a third period” in the invention.

Vₜₕ Correction Preparation Period (T_{d})

After that, the display 1 executes the above-described processes (the Vₜₕ correction preparation period, the Vₜₕ correction period, the Vₜₕ correction stop period, the writing·μ correction period, the bootstrap period, the light-off period and the light-on period) in each frame period. In this case, at a boundary between the previous frame period (an nth frame period in FIG. 3) and the next frame period (an n+1th frame period in FIG. 3), the power source line drive circuit 25 applies the light-off control signal (the falling signal 25A) to the power source line DSL so as to stop the steady current flowing through the selected organic EL element 11. In other words, the power source line drive circuit 25 applies the falling signal 25A (the first light-off control signal) to the power source line DSL so as to stop the steady current flowing through the selected organic EL element 11.

In the display 1 according to the embodiment, as described above, when the on/off state of the pixel circuit 14 in each pixel 12 is controlled, and a drive current is injected into the organic EL elements 11 of each pixel 12, the organic EL elements 11 emit light by the recombination of electrons and holes. The light is multiply reflected between the anode and the cathode, and then passes through the cathode or the like to be extracted. As a result, an image is displayed on the display panel 10.

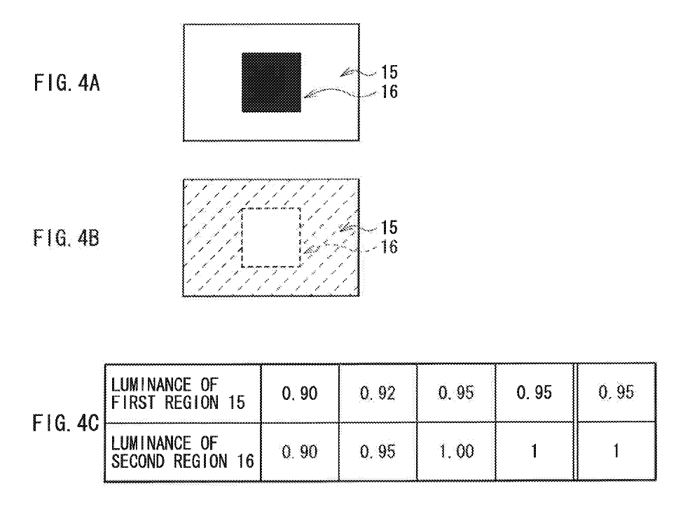

The preferable duration of the Vₜₕ correction preparation period (T_{d}) will be described below. FIG. 4A schematically illustrates an example of a monochrome image displayed on the display panel 10. In addition, FIG. 4A illustrates the case where in the monochrome image, a region (a first region 15) corresponding to white display is located along an outer edge of the display region of the display panel 10, and a region (a second region 16) corresponding to black display is located in the center of the display region. FIG. 4B schematically illustrates an example of an image displayed on the display panel 10 when the whole display region of the display panel 10 displays white after continuously displaying the monochrome image in FIG. 4A. FIG. 4C illustrates luminance of each of the first region 15 and the second region 16 when the duration of the Vₜₕ correction preparation period T_{d} is changed to 3 milliseconds, 2 milliseconds, 1 millisecond and 0.5 milliseconds. In addition, in FIG. 4C, the luminance of the second region 16 when the Vₜₕ correction preparation period T_{d} is 3 milliseconds is set to 1 as a reference value. Moreover, in FIG. 4C, the durations of the Vₜₕ correction preparation period T_{d} are 3 milliseconds, 2 milliseconds, 1 millisecond and 0.5 milliseconds in order from the right.

It is obvious from FIGS. 4A to 4C that in the case where the Vₜₕ correction preparation period T_{d} is approximately from 2 milliseconds to 3 milliseconds, a luminance difference between the first region 15 and the second region 16 is only 0.5. On the other hand, it is obvious that in the case where the Vₜₕ correction preparation period T_{d} is approximately 1 millisecond, the luminance difference is 0.3 which is slightly smaller, and in the case where the Vₜₕ correction preparation period T_{d} is approximately 0.5 milliseconds, there is little luminance difference. Therefore, it is obvious that in the case where the Vₜₕ correction preparation period T_{d} is 1 millisecond or less, even when the whole display region of the display panel 10 displays white after continuously displaying a still image, burn-in is allowed to be reduced or eliminated.

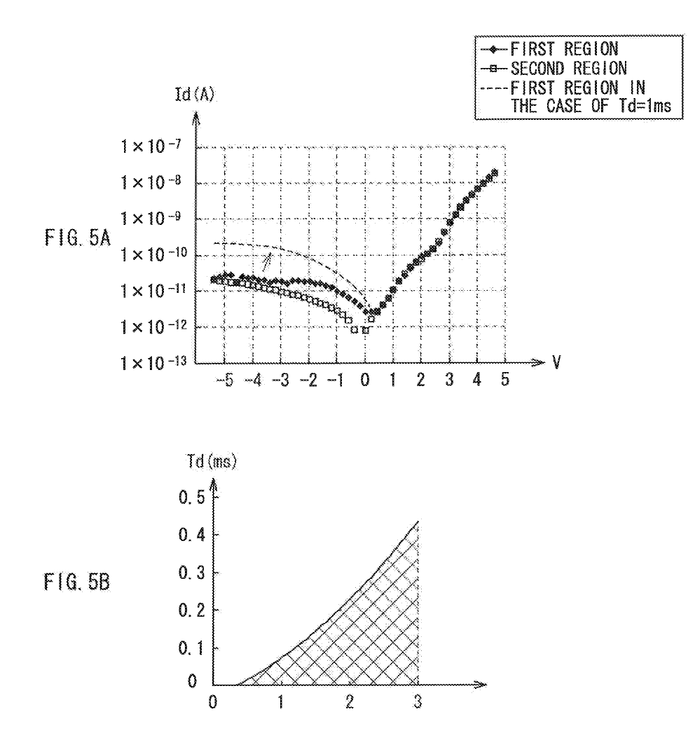

FIG. 5A illustrates an example of a relationship between a voltage V applied to the organic EL element 11 and the current I_{d} flowing through the organic EL element 11. Black dots and a broken line in FIG. 5A indicate results of the organic EL element 11 arranged corresponding to the first region 15, and white dots in FIG. 5A indicate results of the organic EL element 11 arranged corresponding to the second region 16. The black dots and the white dots in FIG. 5A indicate results in the case where the Vₜₕ correction preparation period T_{d} is 3 milliseconds, and the broken line in FIG. 5A indicates results in the case where the Vₜₕ correction preparation period T_{d} is 1 millisecond.

It is obvious from FIG. 5A that when the Vₜₕ correction preparation period T_{d} is reduced, the reverse current of the organic EL element 11 is increased. Therefore, it is assumed that when the Vₜₕ correction preparation period T_{d} is reduced, a luminance difference between the first region 15 and the second region 16 is reduced, because a difference between leakage currents of the organic EL elements 11 in the first region and the second region 16 is reduced with an increase in the reverse currents of the organic EL elements 11.

FIG. 5B illustrates an example of a relationship between the Vₜₕ correction preparation period T_{d} and the light-on period Tₑ. A shaded region in FIG. 5B indicates a region where burn-in does not occur when the whole display region of the display panel 10 displays white after continuously displaying a still image. It is obvious from FIG. 5B that the upper limit of the Vₜₕ correction preparation period T_{d} depends on the duration of the light-on period Tₑ, and the larger the light-on period Tₑ is, the more the upper limit of the Vₜₕ correction preparation period T_{d} increases. For example, in the case where the light-on period Tₑ is 3 ms, the upper limit of the Vₜₕ correction preparation period T_{d} is 0.45 ms. In addition, the upper limit of the Vₜₕ correction preparation period T_{d} is highly limited by the duration of the light-on period Tₑ in the case where the light-on period Tₑ is short, and in the case where the light-on period Tₑ is sufficiently long, the upper limit of the Vₜₕ correction preparation period T_{d} is not substantially limited by the duration of the light-on period Tₑ.

### 1.3 Functions and Effects

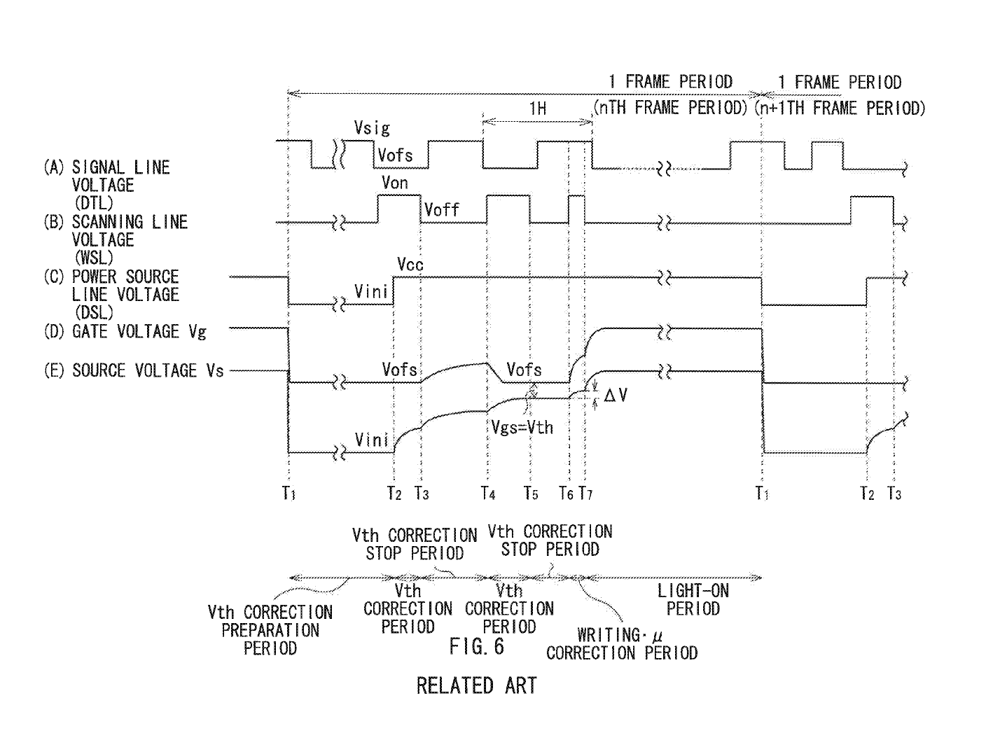

In related art, for example, as illustrated in FIG. 6, a Vₜₕ correction preparation period is arranged for a long duration (from T₁ to T₂) after a lapse of a light-on period (from T₇ to T₁). During the period, a large reverse bias is applied to organic EL elements, and a leakage current slightly flows through the organic EL elements, so in the case where the magnitude of the leakage current differs among pixels, anode voltages of the organic EL elements differ depending on the magnitude of the leakage current. For example, in the case where a predetermined pattern including white and black is displayed for a long time, the magnitude of the leakage current in a pixel corresponding to white display and the magnitude of the leakage current in a pixel corresponding to black display are largely different from each other. As a result, a change in luminance corresponding to the pattern remains, thereby burn-in occurs.

Therefore, for example, to reduce a period where a large reverse bias is applied to the organic EL elements, it is considered that the organic EL elements emit light immediately before starting Vₜₕ correction. However, in such a case, it is necessary to fix the light-on period, so it is difficult to change the light-on period. As a result, there is an issue that it is difficult to control luminance by the light-on period.

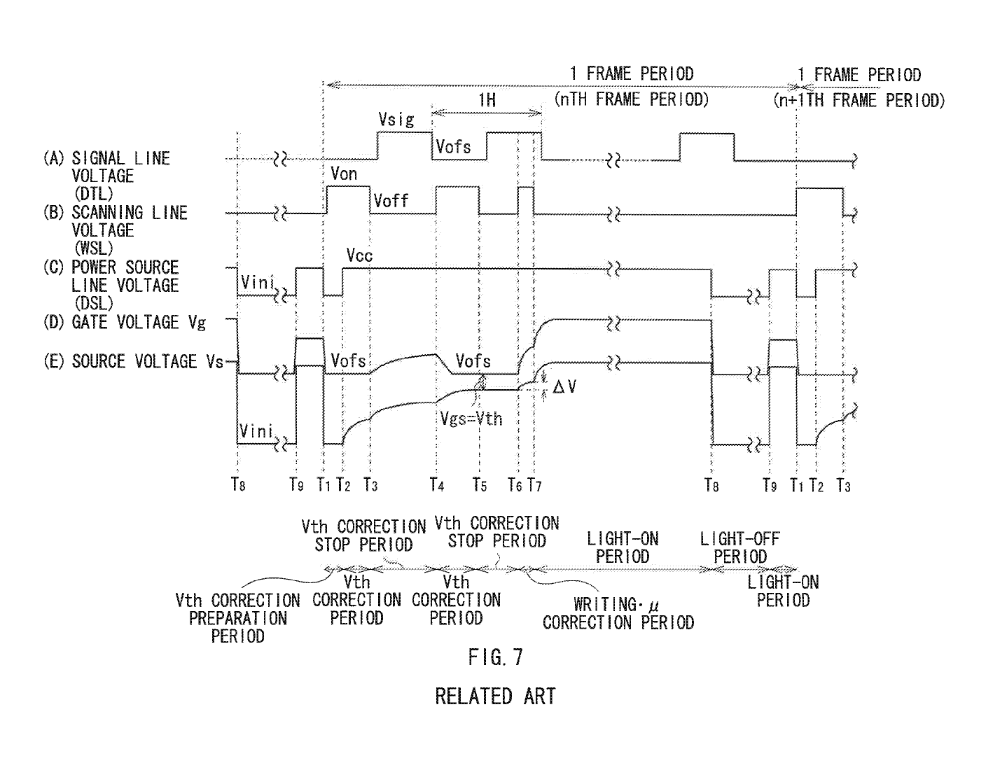

Moreover, for example, as illustrated in FIG. 7, it is considered that a short light-on period (from T₉ to T₁) is arranged immediately before the Vₜₕ correction preparation period to increase the reverse currents of the organic EL elements 11, thereby a difference in leakage current among the organic EL elements 11 is reduced. However, in such a case, light is emitted twice in one field period, so an image is blurred.

On the other hand, in the embodiment, a light emission potential corresponding to the picture signal 20A is written to a selected pixel circuit 14 (between the gate and the source of the driving transistor Tr₁) by the signal line drive circuit 23. After that, the power source line drive circuit 25 outputs the falling signal 25A at a lapse of the wiring·μ correction period and the bootstrap period (T_{b}). After that, the power source line drive circuit 25 outputs the rising signal 25B at a lapse of the light-off period, and then outputs the falling signal 25A at a lapse of the light-on period (Tₑ) longer than the bootstrap period T_{b}. Thereby, the duration of the light-off period is appropriately adjusted so as to change the light-on period (Tₑ). As a result, while having flexibility in the light-on period, burn-in on the panel is preventable.

Moreover, in the embodiment, the bootstrap period (from T₈ to T₉) is too short to reach the time when the organic EL element 11 starts emitting light. Alternatively, the bootstrap period (from T₈ to T₉) is too short for a viewer (not illustrated) to discriminate between light emission from the organic EL element 11 in the bootstrap period and light emission from the organic EL element 11 in the light-on period. Therefore, visible light emission for the viewer occurs only once in one field period, so there is little possibility that an image is blurred.

### 2. Modifications

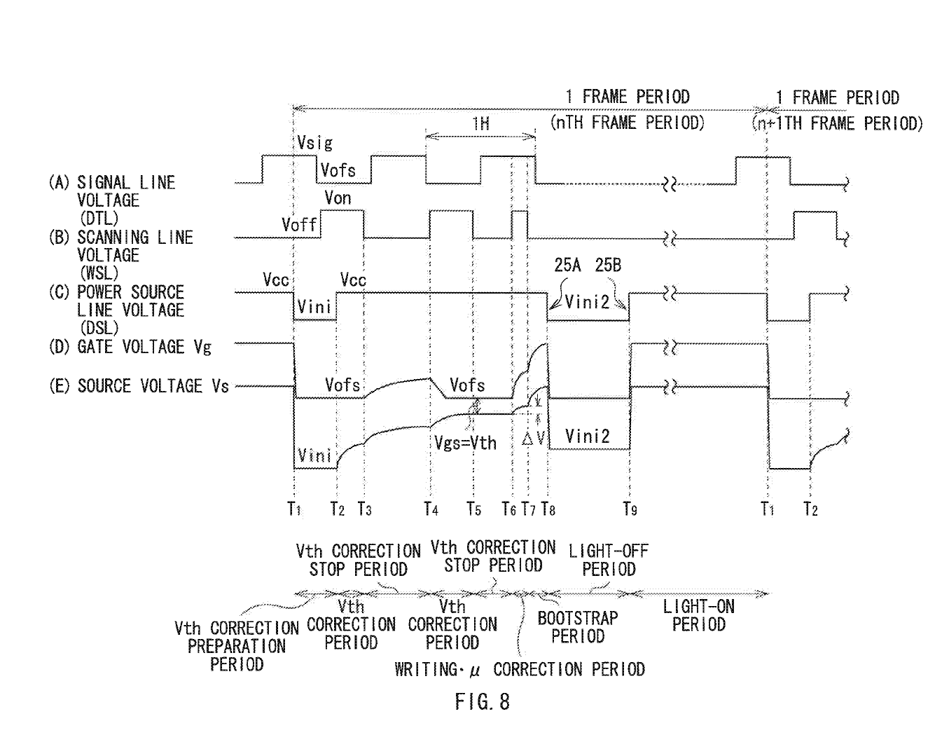

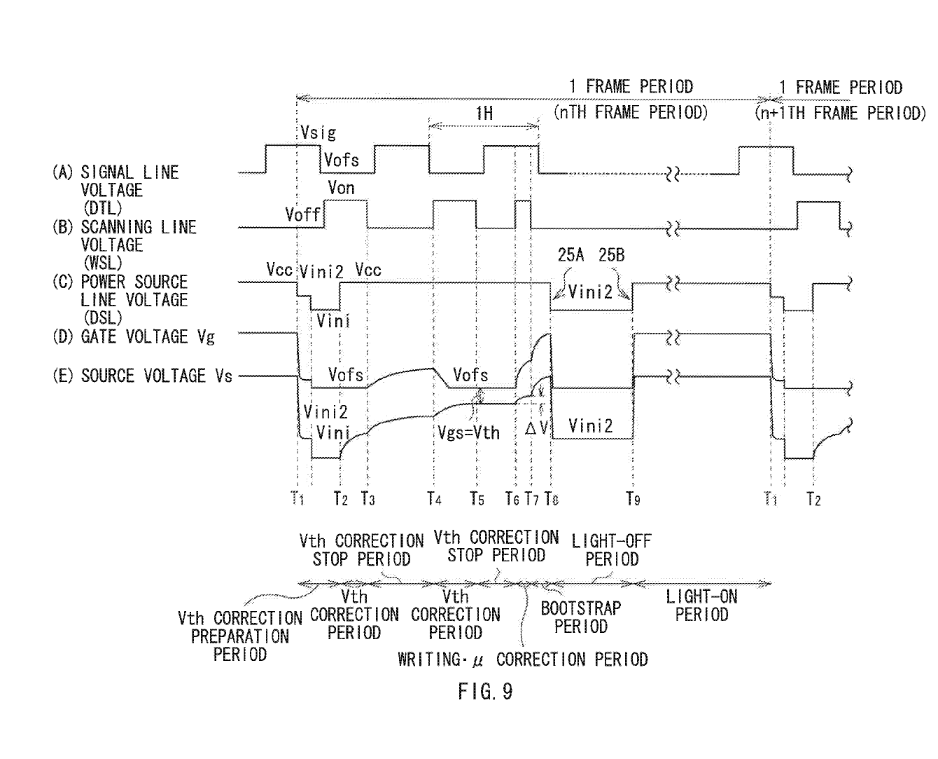

In the above-described embodiment, a potential (a potential in the light-off period (from T₈ to T₉)) after outputting the falling signal 25A by the power source line drive circuit 25 is Vᵢₙᵢ. However, for example, as illustrated in FIG. 8, the potential may be a potential Vᵢₙᵢ₂ (an intermediate potential) which is higher than the potential Vᵢₙᵢ. In such a case, a decrease in the gate potential of the driving transistor Tr₁ is allowed to be reduced through the writing transistor Tr₂. Moreover, for example, as illustrated in FIG. 9, not only a potential in the light-off period (from T₈ to T₉) but also a potential in a part or the whole of the Vₜₕ correction preparation period (from T₁ to T₂) may be also the potential Vᵢₙᵢ₂ (the intermediate potential) which is higher than the potential Vᵢₙᵢ.

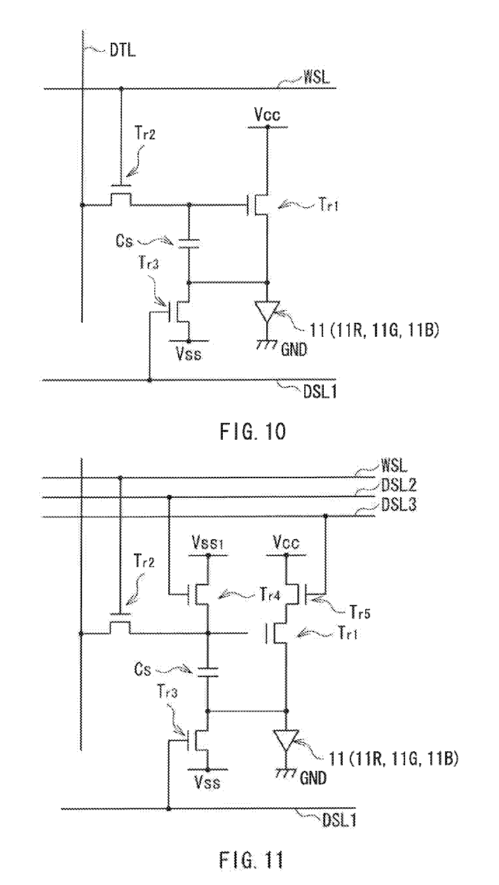

Further, in the above-described embodiment, the pixel circuits 14 each have a 2Tr1C-circuit configuration. However, the pixel circuits 14 may have any other circuit configuration, for example, as illustrated in FIGS. 10 and 11.

### 3. Module and Application Examples

Application examples of the display described in the above-described embodiment will be described below. The display according to the above-described embodiment is applicable to displays of electronic devices displaying a picture signal inputted from outside or a picture signal produced inside as an image or a picture in any fields, such as televisions, digital cameras, notebook personal computers, portable terminal devices such as cellular phones, and video cameras.

Module

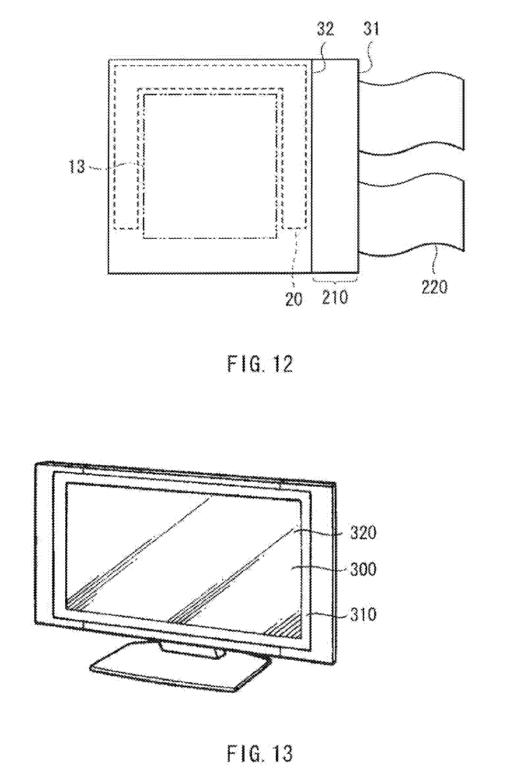

The display according to the above-described embodiment is incorporated into various electronic devices such as Application Examples 1 to 5 which will be described later as a module as illustrated in FIG. 12. In the module, for example, a region 210 exposed from the sealing substrate 32 is arranged on a side of a substrate 31, and an external connection terminal (not illustrated) is formed in the exposed region 210 by extending the wiring of the drive circuit 20. In the external connection terminal, a flexible printed circuit (FPC) 220 for signal input/output may be arranged.

### Application Example 1

FIG. 13 illustrates an appearance of a television to which the display according to the above-described embodiment is applied. The television has, for example, a picture display screen section 300 including a front panel 310 and a filter glass 320. The picture display screen section 300 is configured of the display according to the above-described embodiment.

### Application Example 2

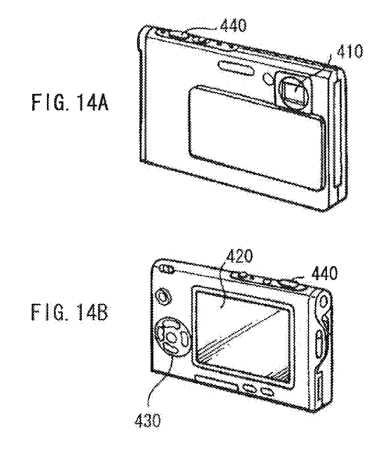

FIGS. 14A and 14B illustrate appearances of a digital camera to which the display according to the above-described embodiment is applied. The digital camera has, for example, a light-emitting section for a flash 410, a display section 420, a menu switch 430, and a shutter button 440. The display section 420 is configured of the display according to the embodiment.

### Application Example 3

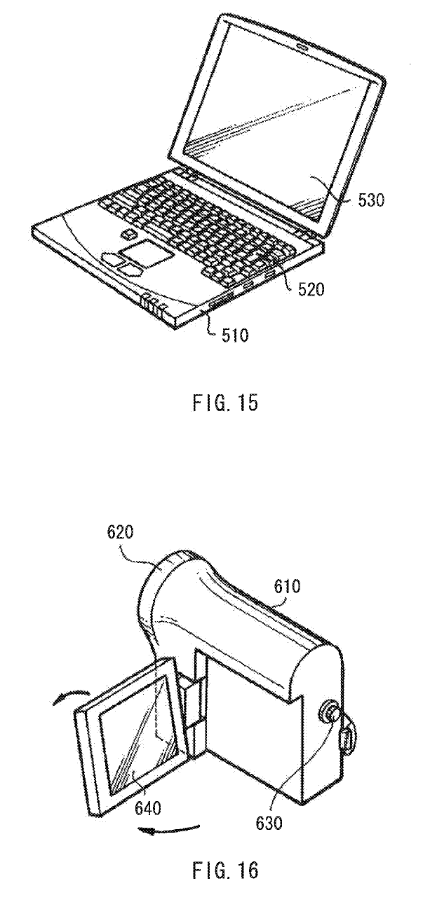

FIG. 15 illustrates an appearance of a notebook personal computer to which the display according to the above-described embodiment is applied. The notebook personal computer has, for example, a main body 510, a keyboard 520 for operation of inputting characters and the like, and a display section 530 for displaying an image. The display section 530 is configured of the display according to the above-described embodiment.

### Application Example 4

FIG. 16 illustrates an appearance of a video camera to which the display according to the above-described embodiment is applied. The video camera has, for example, a main body 610, a lens for shooting an object 620 arranged on a front surface of the main body 610, a shooting start/stop switch 630, and a display section 640. The display section 640 is configured of the display according to the above-described embodiment.

### Application Example 5

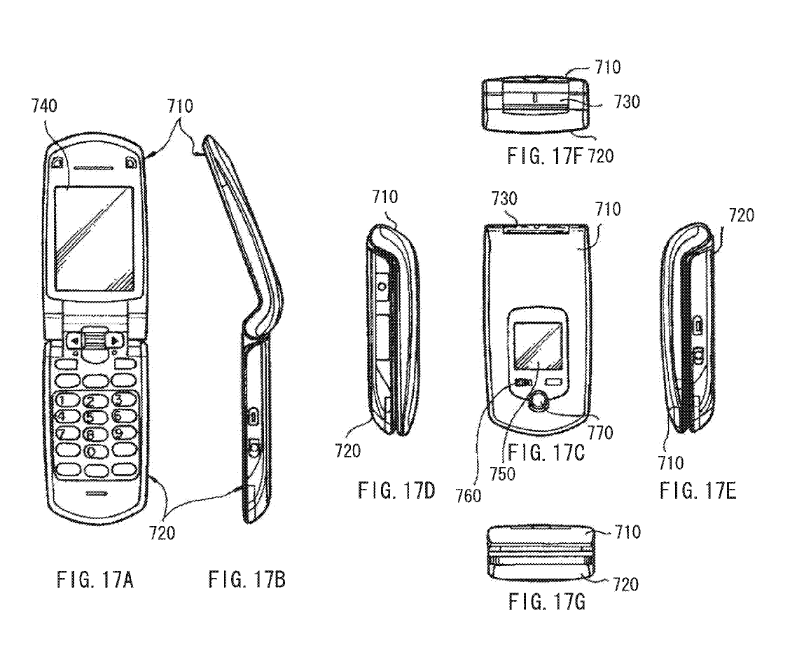

FIGS. 17A to 17G illustrate appearances of a cellular phone to which the display according to the above-described embodiment is applied. The cellular phone is formed by connecting, for example, a top-side enclosure 710 and a bottom-side enclosure 720 to each other by a connection section (hinge section) 730. The cellular phone has a display 740, a sub-display 750, a picture light 760, and a camera 770. The display 740 or the sub-display 750 is configured of the display according to the above-described embodiment.

The present application contains subject matter related to that disclosed in Japanese Priority Patent Application JP 2009-094740 filed in the Japan Patent Office on Apr. 9, 2009, the entire content of which is hereby incorporated by references.

It should be understood by those skilled in the art that various modifications, combinations, sub-combinations and alterations may occur depending on design requirements and other factors insofar as they are within the scope of the appended claims or the equivalents thereof.

What is claimed is:

1. A display comprising:
a pixel circuit array section including a plurality of scanning lines and a plurality of light-on/off control lines which are arranged in a row direction, a plurality of signal lines which are arranged in a column direction, and a plurality of light-emitting elements and a plurality of pixel circuits which are arranged in a matrix form corresponding to intersections between the scanning lines and the signal lines, respectively;
a scanning line drive circuit sequentially applying a selection pulse to the plurality of scanning lines so as to sequentially select the plurality of light-emitting elements and the plurality of the pixel circuits;
a signal line drive circuit applying a signal potential corresponding to a picture signal to each of the signal lines so as to write a light emission potential corresponding to the signal potential to a selected pixel circuit; and
a control circuit sequentially applying a light-on control signal to the plurality of light-on/off control lines so as to allow a steady current corresponding to the light emission potential to flow into a selected light-emitting element, and sequentially applying a light-off control signal to the plurality of light-on/off control lines so as to stop the steady current flowing through the selected light-emitting element,
wherein in each frame period, the control circuit outputs the light-off control signal (a first light-off control signal) at a lapse of a first period after writing the light emission potential to the selected pixel circuit by the signal line drive circuit, and then the control circuit outputs the light-on control signal at a lapse of a second period, and after that, the control circuit outputs the light-off control signal (a second light-off control signal) at a lapse of a third period which is longer than the first period.

2. The display according to claim 1, wherein
the control circuit outputs the second light-off control signal at a boundary between an nth frame period (where n is a positive integer) and an n+1 frame period, and then the control circuit outputs a correction start signal for starting correction of a potential of a part to which the light emission potential is to be written in the pixel circuit at a lapse of a fourth period.

3. The display according to claim 2, wherein
the fourth period is 1 millisecond or less.

4. The display according to claim 1, wherein
the first period is too short to reach the time when the light-emitting element starts emitting light by writing the light emission potential, or the first period is too short for a viewer to discriminate between light emission from the light-emitting element by writing the light emission potential and light emission from the light-emitting element by outputting the light-on control signal.

5. The display according to claim 4, wherein
the control circuit outputs the first light-off control signal immediately before, at the moment, or immediately after when the light-emitting element starts emitting light.

6. A method of driving a display, the display including:
a pixel circuit array section including a plurality of scanning lines and a plurality of light-on/off control lines which are arranged in a row direction, a plurality of signal lines which are arranged in a column direction, and a plurality of light-emitting elements and a plurality of pixel circuits which are arranged in a matrix form corresponding to intersections between the scanning lines and the signal lines, respectively;
a scanning line drive circuit sequentially applying a selection pulse to the plurality of scanning lines so as to sequentially select the plurality of light-emitting elements and the plurality of the pixel circuits;
a signal line drive circuit applying a signal potential corresponding to a picture signal to each of the signal lines so as to write a light emission potential corresponding to the signal potential to a selected pixel circuit; and
a control circuit sequentially applying a light-on control signal to the plurality of light-on/off control lines so as to allow a steady current corresponding to the light emission potential to flow into a selected light-emitting element, and sequentially applying a light-off control signal to the plurality of light-on/off control lines so as to stop the steady current flowing through the selected light-emitting element, the method comprising the step of:
in the display, in each frame period, outputting the light-off control signal (a first light-off control signal) at a lapse of a first period after writing the light emission potential to the selected pixel circuit by the signal line drive circuit, and then outputting the light-on control signal at a lapse of a second period, and after that, outputting the light-off control signal (a second light-off control signal) at a lapse of a third period which is longer than the first period.
